(19) United States
(12) Patent Application Publication
(10) Pub. No.: US 2015/0169604 A1
(43) Pub. Date: Jun. 18, 2015

(54) VEHICLE DATA CONTROL SYSTEM AND METHOD

(71) Applicant: Hyundai Motor Company, Seoul (KR)

(72) Inventors: Min Hyuk Oh, Seoul (KR); Young Woo Park, Yongin (KR); Hyun Woo Lee, Yongin (KR); Hae Young Kwon, Suwon (KR)

(73) Assignee: HYUNDAI MOTOR COMPANY, Seoul (KR)

(21) Appl. No.: 14/526,213

(22) Filed: Oct. 28, 2014

(30) Foreign Application Priority Data
Dec. 13, 2013 (KR) 10-2013-0155579

(51) Int. Cl. G06F 17/30

(52) U.S. Cl. CPC G06F 17/30091; G06F 17/30082

(57) ABSTRACT

A vehicle data control system and method are provided. The vehicle data control system includes a file system that has a first partition as a read only memory configured to store and manage basic vehicle content, a second partition as a readable/writable memory configured to store and manage the basic vehicle content, and a third partition as a readable/writable memory configured to store and manage user content. In addition, a display unit is configured to display an image according to execution of at least one selected from between the basic vehicle content and the user content.

### CROSS REFERENCE TO RELATED APPLICATION

This application claims the benefit of Korean Patent Application No. 10-2013-0155579, filed on Dec. 13, 2013, which is hereby incorporated by reference as if fully set forth herein.

### BACKGROUND

1. Field of the Invention

The present invention relates to a vehicle data control system and method.

2. Discussion of the Related Art

General-purpose operating systems (OS) used in mobile devices, such as a mobile phone and a tablet personal computer (PC), have been applied to a vehicle. With the use of general-purpose operating systems, a user may download, store, and manage user content in a file system of a vehicle in the same manner as in the mobile devices.

When the user content is downloaded and used in the file system of the vehicle, the system may be shut down by viruses or malicious code. For a general mobile device, the system may be recovered through rebooting the device even when the system is shut down. For a vehicle, however, a driving function may be damaged and, in addition, a problem related to user safety may be caused when the system is shut down while the vehicle is traveling.

### SUMMARY

Accordingly, the present invention provides a vehicle data control system and method that prevent user content from accessing a main system area requiring reliability and security. Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a vehicle data control system includes a file system that may include a first partition as a read only memory to store and manage basic vehicle content, a second partition as a readable/writable memory to store and manage the basic vehicle content, and a third partition as a readable/writable memory to store and manage user content and a display unit to display an image according to execution of at least one selected from between the basic vehicle content and the user content.

The file system may further include a data type identification unit to identify type of vehicle data and a partition decision unit to determine a partition in which the vehicle data are stored based on the identified type of the vehicle data. The partition decision unit may be executed by a controller to determine a partition in which the vehicle data are stored by assigning an address to the vehicle data based on predetermined table information. The predetermined table information may define a relationship among types of the vehicle data, partition addresses, and partitions corresponding thereto. The display unit may be executed by the controller to display multi-layer images having at least two layers. The at least two layers may include a first layer and a second layer. The first layer may be an area to display an image according to execution of the basic vehicle content of the first partition and the second partition and the second layer may be an area to display an image according to execution of the user content.

In another aspect of the present invention, a vehicle data control method may include loading a file system having basic vehicle content and user content stored therein, generating a first execution code that indicates a command to execute the basic vehicle content and a second execution code according to a user content execution command, generating a first layer image that corresponds to the basic vehicle content based on the first execution code, generating a second layer image that corresponds to the user content based on the second execution code, and displaying the first layer image and the second layer image.

The vehicle data control method may further include monitoring whether the second layer image has an error and, upon determining that the second layer image has an error, terminating the user content. The displaying step may include resizing the first layer image and the second layer image using screen size information of a cluster display unit and downsizing the resized images using size control information of the first layer image and the second layer image. The size control information may be image size information determined within a range in which the first layer image and the second layer image do not overlap in the cluster display unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is an exemplary schematic block diagram of a vehicle data control system according to an exemplary embodiment of the present invention;

FIG. 2 is an exemplary view schematically showing construction of a file system according to an exemplary embodiment of the present invention;

FIG. 3 is an exemplary flowchart showing a method of storing, by the file system, vehicle data in a partition based on the type of vehicle data according to an exemplary embodiment of the present invention;

FIG. 4 is an exemplary flowchart showing a method of displaying multi-layer images according to an exemplary embodiment of the present invention; and

FIG. 5 is an exemplary flowchart showing a method of displaying, by a display controller, multi-layer images according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference will now be made in detail to the exemplary embodiments of the present invention, examples of which are illustrated in the accompanying drawings. First of all, terminology used in this specification and claims must not be construed as limited to the general or dictionary meanings thereof and should be interpreted as having meanings and concepts matching the technical idea of the present invention based on the principle that an inventor is able to appropriately define the concepts of the terminologies to describe the invention in the best way possible. The exemplary embodiment disclosed herein and configurations shown in the accompanying drawings are only one exemplary embodiment and do not represent the full technical scope of the present invention. Therefore, it is to be understood that the present invention covers the modifications and variations of this invention provided they come within the scope of the appended claims and their equivalents when this application was filed.

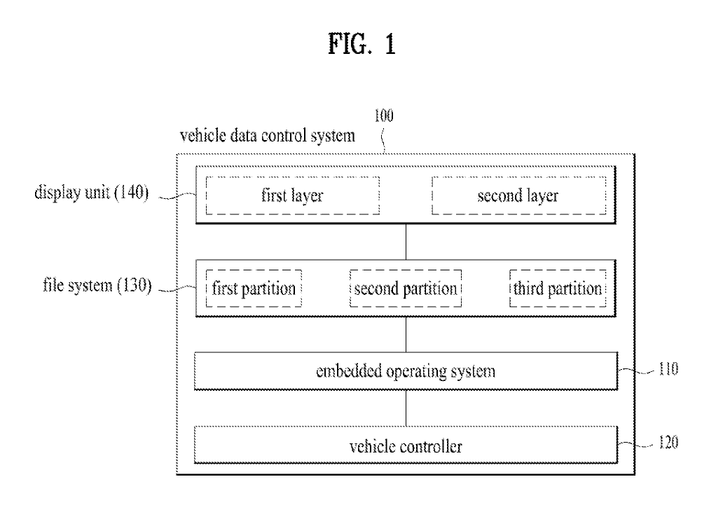

FIG. 1 is an exemplary schematic block diagram of a vehicle data control system 100 according to an exemplary embodiment of the present invention. Referring to FIG. 1, the vehicle data control system 100 may include an embedded operating system 110, a vehicle controller 120, a file system 130, and a display unit 140. The vehicle controller 120 may be configured to operate the embedded operating system 110, the file system 130, and the display unit 140.

The embedded operating system 110 may be a program to interface between hardware and an application program. The embedded operating system 110 may be configured to manage a plurality of resources, such as a central processing unit (CPU), a main memory, and input and output devices. In addition, the embedded operating system 110 may be configured to execute the application program and manage storage of data and files. In addition, the vehicle controller 120 may be configured to operate travel and state of a vehicle. The vehicle controller 120 may be connected to the embedded operating system via vehicle network communication (e.g. controller area network (CAN) communication) to exchange data related to travel and state of the vehicle. The file system 130 may be configured to store and manage user content and data related to travel and state of the vehicle. The file system 130 may include a plurality of partitions to prevent user content from penetrating into a main system of the file system. Hereinafter, the file system 130 will be described as including three partitions for the convenience of description.

As shown in FIG. 1, the file system 130 may include three partitions, such as a first partition, a second partition, and a third partition. The first partition may be a read only memory configured to store and manage applications and data related to travel and state of the vehicle (hereinafter, referred to as basic vehicle content). Access from other partitions to the first partition may be intercepted to secure reliability of data stored in the first partition. Since data stored in the first partition may be changed and access from other partitions to the first partition may be intercepted, the first partition may be configured to store and manage applications and data related to a speed gauge, an revolutions per minute (RPM) gauge, an alarm gauge, a fuel gage, etc.

The second partition may be a readable and writable memory configured to store and manage basic vehicle content in the same manner as in the first partition. Access from other partitions to the second partition may also be intercepted to secure reliability of data stored in the second partition. However, some data may be written through a predetermined access route. Consequently, the second partition may be configured to store and manage writable data, such as cluster travel distance information and average efficiency information.

The third partition may be a readable and writable memory configured to store and manage user-provided applications and data (i.e. user content). Access from the third partition to other partitions may be intercepted. Consequently, the other partitions may not be overwritten and the third partition may not affect the other partitions although the third partition may be contaminated by viruses.

The display unit 140 may be configured to display an image according to execution of at least one selected from between the basic vehicle content stored in the file system 130 and the user content. As shown in FIG. 1, the display unit 140 may be configured to display multi-layer images having multi layers, (e.g. at least two layers, first layer and second layer). In particular, the first layer may be an area to display an image according to execution of the basic vehicle content of the first partition and the second partition and the second layer may be an area to display an image according to execution of the user content.

FIG. 1 shows that the display unit 140 may include two layers; however, the present invention is not limited thereto. For example, the display unit 140 may be configured to display multi-layer images using three layers, such as a first layer, a second layer, and a third layer, that correspond to the partitions of the file system. In particular, the first layer may be an area configured to display an image according to execution of the applications or data stored in the first partition, the second layer may be an area configured to display an image according to execution of the applications or data stored in the second partition, and the third layer may be an area configured to display an image according to execution of the user content. The respective layers may be configured not to overlap such that the layer related to the user content may be prevented from penetrating into the layers related to travel/state of the vehicle, which require reliability.

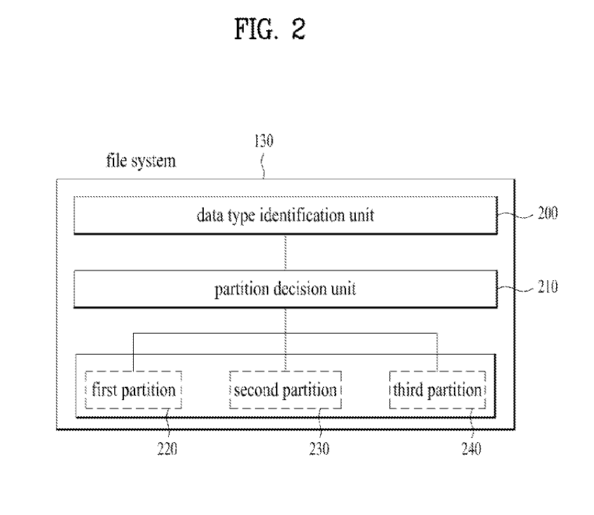

FIG. 2 is an exemplary view schematically showing construction of a file system 130 according to an exemplary embodiment of the present invention. The file system 130 may be configured to store vehicle data received by the file system 130 in a partition that corresponds to the vehicle data based on the type of the vehicle data. Accordingly, the file system 130 may include a first partition 220, a second partition 230, and a third partition 240. In addition, the file system 130 may further include a data type identification unit 200 and a partition decision unit 210 executed by the controller 120. The partitions 220, 230, and 240 were previously described with reference to FIG. 1 and, therefore, a detailed description thereof will be omitted.

The data type identification unit 200 may be configured to identify and determine a type of vehicle data received by the file system. The vehicle data may include applications and data related to travel/state of the vehicle and user-provided applications and data. In other words, the data type identification unit 200 may be configured to identify whether the received vehicle data is read only data (hereinafter, referred to as data type A) of the applications and data related to travel/state of the vehicle, readable/writable data (hereinafter, referred to as data type B) of the applications and data related to travel/state of the vehicle, or data (hereinafter, referred to as data type C) that corresponds to the user content.

The partition decision unit 210 may be configured to determine a partition in which the corresponding vehicle data is stored based on the data type identified by the data type identification unit 200. For example, when the type of the received vehicle data is data type A, an address of the partition in which the read only data of the applications and data related to travel/state of the vehicle are stored may be assigned to the corresponding vehicle data. The address may be a memory address in which the vehicle data are stored.

The vehicle data may be transmitted to, stored in, and managed by the partition that corresponds to the assigned address. Specifically, when the type of the received vehicle data is data type A, an address (address 1) of the first partition may be assigned and the vehicle data may be transmitted to, stored in, and managed by the first partition that corresponds to address 1. Accordingly, the file system may be configured to assign the partition address based on the type of the vehicle data to prevent the user content from being transmitted to the first partition or the second partition, which requires reliability.

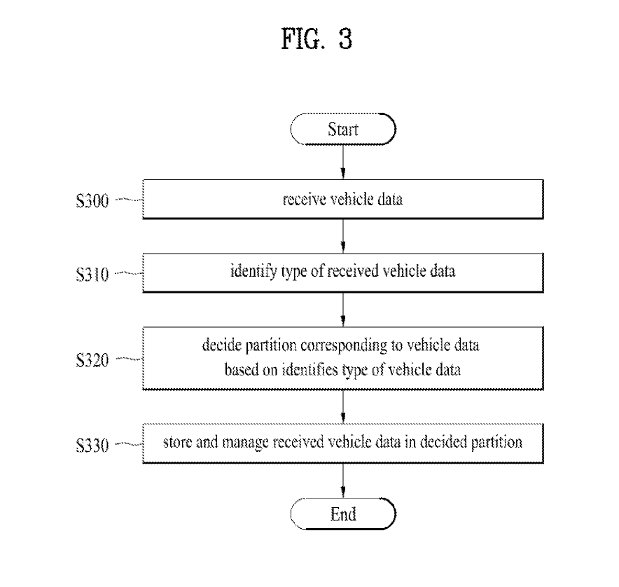

FIG. 3 is an exemplary flowchart showing a method of storing, by the file system 130, vehicle data in a partition based on the type of vehicle data according to an exemplary embodiment of the present invention. First, the file system may be configured to receive vehicle data (S300). As previously described with reference to FIG. 2, the vehicle data may include applications and data related to travel/state of the vehicle and user-provided applications and data.

Subsequently, the file system may be configured to identify and determine the type of the received vehicle data (S310). Specifically, the file system may be configured identify whether the vehicle data corresponds to the applications or data (data type A or data type B) related to travel/state of the vehicle or user-provided applications or data (data type C). In addition, when the vehicle data corresponds to the applications or data related to travel/state of the vehicle, the file system may be configured to identify whether the vehicle data is read only data (data type A) or readable/writable data (data type B).

Further, the file system may be configured to determine a partition that corresponds to the vehicle data based on the identified type of the vehicle data (S320). In particular, the partition that corresponds to the vehicle data may be determined by assigning a partition address to the corresponding vehicle data based on predetermined table information. The predetermined table information may define a relationship among types of the vehicle data, partition addresses, and partitions corresponding thereto. The predetermined table information may be stored in the file system 130. For example, the predetermined table information may be defined as shown in Table 1 below.

TABLE 1

| | Type of | Partition | Corresponding |
|---|---|---|---|
| o. | vehicle data | address | partition |
| | Data type A | Address 1 | First partition |
| | Data type B | Address 2 | Second partition |
| | Data type C | Address 3 | Third partition |

Referring to Table 1, the predetermined table information may define partition addresses assigned according to the type of the vehicle data and a partition corresponding to each partition address. The received vehicle data may be transmitted to, stored in, and managed by the partition determined at step S320.

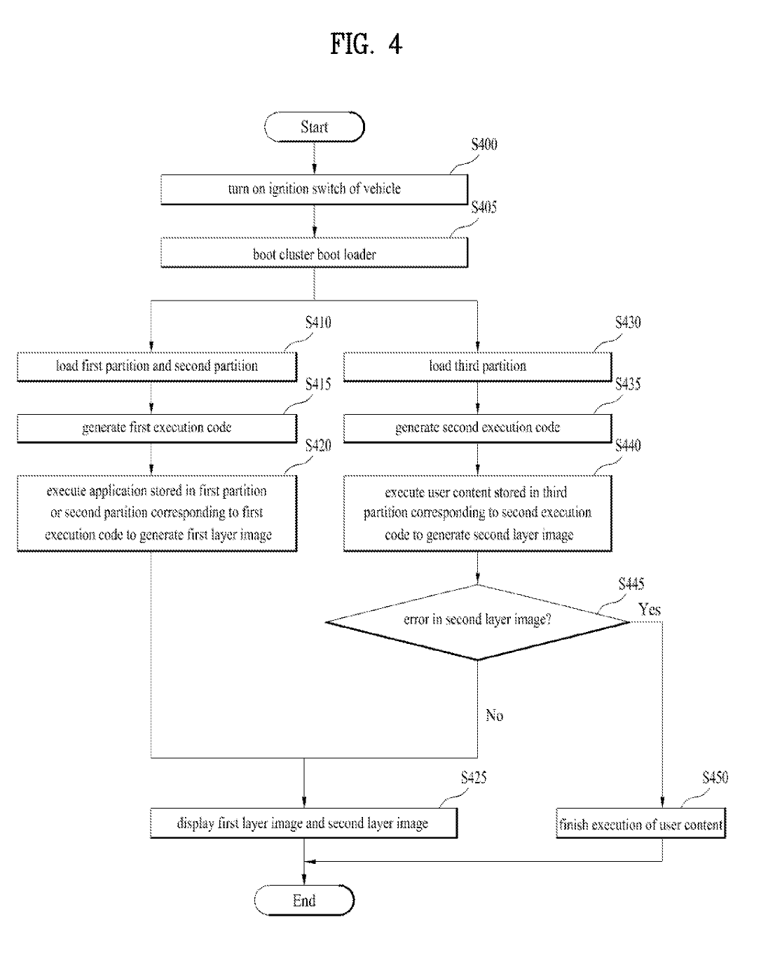

FIG. 4 is an exemplary flowchart showing a method of displaying multi-layer images according to an exemplary embodiment of the present invention. When an ignition switch of the vehicle is turned ON (S400), a cluster boot loader may be booted (S405) and a first partition and a second partition may be loaded (S410). The first partition may be configured to store and manage basic vehicle content. The first partition may be a read only memory. The second partition may be configured to store and manage basic vehicle content in the same manner as in the first partition. However, the second partition may be a readable/writable memory.

Subsequently, an execution code (hereinafter, referred to as a first execution code) that indicates a command to execute the basic vehicle content of at least one of the first and second partitions may be generated (S415). An application stored in the first partition or the second partition that corresponds to the first execution code generated at step S415 may be executed to generate a first layer image (S420). When the cluster boot loader is booted (S405), on the other hand, a third partition may be loaded (S430). The third partition may be configured to store and manage user content and may be a readable/writable memory. The third partition may be loaded simultaneously when the cluster boot loader is booted. Alternatively, the third partition may be loaded when a user loading command is received since the third partition may be an area configured to store user-provided applications and data.

When a user content execution command is received from a user, an execution code (hereinafter, referred to as a second execution code) according to the user content execution command may be generated (S435). User content stored in the third partition that corresponds to the second execution code generated at step S435 may be executed to generate a second layer image (S440).

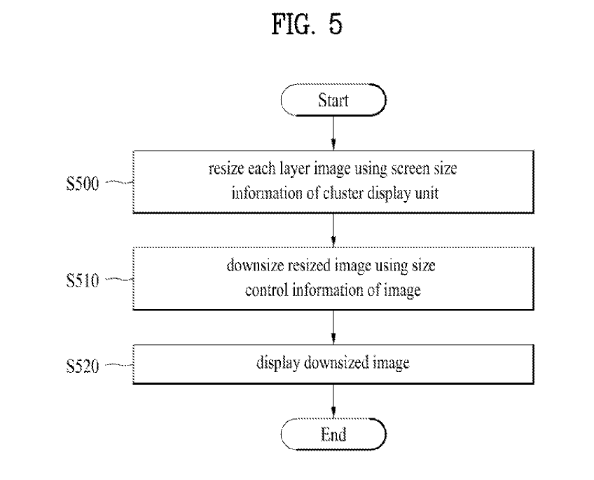

The first layer image generated at step S420 and the second layer image generated at step S440 may be displayed by the controller 120 (S425). A method of displaying multi-layer images without overlapping will be described with reference to FIG. 5. Meanwhile, whether the user content has been erroneously executed and whether the generated second layer image has an error may be monitored by the controller 120 (S445).

In response to determining that the user content has been erroneously executed and/or that the generated second layer image has an error, the execution of the user content may be terminated by the controller (S450). For example, generation of the execution code according to the user content execution command, i.e. the second execution code, may be intercepted to terminate the user content. Alternatively, a finish code that indicates a forced finish command of the user content being executed may be used.

FIG. 5 is an exemplary flowchart showing a method of displaying, by a display controller, multi-layer images according to an exemplary embodiment of the present invention. When one cluster display unit displays multi-layer images, i.e. a plurality of layer images, it the images may be adjusted such that the images do not overlap. When data related to travel/state of the vehicle provided to the user, is hidden by data related to user content, the user may be in danger while driving the vehicle (e.g., vehicle collision risk may increase).

Referring to FIG. 5, each layer image generated at step S425 may be resized using screen size information of the cluster display unit (S500). The screen size information of the cluster display unit may include screen height and width information. In addition, resizing may include adjusting each layer image into an image having about the same size as the cluster display unit. In particular, when the generated image has a smaller size that the display unit, the image may be upsampled (e.g., the image size may be increased). In other words, an interpolation filter may be applied to each sample of the generated image to generate an upsampled image. The interpolation filter may be preset in the display controller (not shown). A bi-linear filter or a tap filter may be adaptively used in consideration of quality and complexity of the image. Additionally, when the generated image has a greater size that the display unit, the image may be downsampled (e.g., the image size may be decreased).

Subsequently, the resized image may be downsized using size control information of the image (S510). The size control information may image size information determined within a range in which a plurality of images does not overlap in the cluster display unit. For example, the size control information may be height and width information of the image. Alternatively, the size control information may be a ratio in area of the image to the cluster display unit. Meanwhile, the size control information may be preset in the display controller (not shown) per layer image or set by a user input. Since each layer image may be downsized using the size control information as described above, the images may be adjust to not overlap in the cluster display unit. The image downsized at step S510 may be displayed (S520).

As is apparent from the above description, a partition for user content may be provided in a vehicle file system. Consequently, it may be possible for a user to freely download a desired application (e.g. a weather application or a cluster background screen application), thus improving user satisfaction. In addition, a main partition requiring reliability and security and a partition for user content may be separately provided through partitioning of the vehicle file system to intercept access of the user content to a main system. Further, it may be possible to constantly and more correctly provide a basic service of a vehicle system.

Moreover, multi-layer images may be provided such that an image that corresponds to a basic vehicle function application and an image that corresponds to user content do not overlap. Accordingly, it may be possible to constantly provide main data related to travel/state of the vehicle to the user.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A vehicle data control system, comprising:
a file system including a first partition as a read only memory executed by a processor to store and manage basic vehicle content, a second partition as a readable/writable memory executed by the processor to store and manage the basic vehicle content, and a third partition as a readable/writable memory executed by the processor to store and manage user content; and
a display unit configured to display an image according to execution of at least one selected from between the basic vehicle content and the user content.

2. The vehicle data control system according to claim 1, wherein the processor is further configured to:
determine a type of vehicle data; and
determine a partition in which the vehicle data is stored based on the identified type of the vehicle data.

3. The vehicle data control system according to claim 2, wherein the controller is further processor to:
determined the partition in which the vehicle data is stored by assigning an address to the vehicle data based on predetermined table information,
wherein the predetermined table information defines a relationship among types of the vehicle data, partition addresses, and partitions corresponding thereto.

4. The vehicle data control system according to claim 1, wherein the display unit is configured to display multi-layer images having at least two layers.

5. The vehicle data control system according to claim 4, wherein the at least two layers include a first layer and a second layer, and the first layer is an area configured to display an image according to execution of the basic vehicle content of the first partition and the second partition and the second layer is an area configured to display an image according to execution of the user content.

6. A vehicle data control method, comprising:
loading, by a processor, a file system having basic vehicle content and user content stored therein;
generating, by the processor, a first execution code indicating a command to execute the basic vehicle content and a second execution code according to a user content execution command;
generating, by the processor, a first layer image that corresponds to the basic vehicle content based on the first execution code;
generating, by the processor, a second layer image that corresponds to the user content based on the second execution code; and
displaying, by the processor, the first layer image and the second layer image.

7. The vehicle data control method according to claim 6, wherein the file system includes:
a first partition as a read only memory configured to store and manage the basic vehicle content;
a second partition as a readable/writable memory configured to store and manage the basic vehicle content; and
a third partition as a readable/writable memory configured to store and manage the user content.

8. The vehicle data control method according to claim 6, further comprising:
monitoring, by the processor, whether the second layer image has an error; and
in response to determining that the second layer image has an error, terminating, by the processor, the user content.

9. The vehicle data control method according to claim 6, wherein the displaying process includes:
resizing, by the processor, the first layer image and the second layer image using screen size information of a cluster display unit; and
downsizing, by the processor, the resized images using size control information of the first layer image and the second layer image.

10. The vehicle data control method according to claim 9, wherein the size control information is image size information determined within a range in which the first layer image and the second layer image do not overlap in the cluster display unit.

11. A non-transitory computer readable medium containing program instructions executed by a processor, the computer readable medium comprising:
program instructions that load a file system having basic vehicle content and user content stored therein;
program instructions that generate a first execution code indicating a command to execute the basic vehicle content and a second execution code according to a user content execution command;
program instructions that generate a first layer image that corresponds to the basic vehicle content based on the first execution code;
program instructions that generate a second layer image that corresponds to the user content based on the second execution code; and
program instructions that display the first layer image and the second layer image.

12. The non-transitory computer readable medium of claim 11, wherein the file system includes:
a first partition as a read only memory configured to store and manage the basic vehicle content;
a second partition as a readable/writable memory configured to store and manage the basic vehicle content; and
a third partition as a readable/writable memory configured to store and manage the user content.

13. The non-transitory computer readable medium of claim 11, further comprising:
program instructions that monitor whether the second layer image has an error; and
program instructions that terminate the user content in response to determining that the second layer image has an error.

14. The non-transitory computer readable medium of claim 11, further comprising:
program instructions that resize the first layer image and the second layer image using screen size information of a cluster display unit; and
program instructions that downsize the resized images using size control information of the first layer image and the second layer image.

15. The non-transitory computer readable medium of claim 11, wherein the size control information is image size information determined within a range in which the first layer image and the second layer image do not overlap in the cluster display unit.
